(19) United States
(12) Patent Application Publication
(10) Pub. No.: US 2015/0104607 A1
(43) Pub. Date: Apr. 16, 2015

(54) CUSTOM SKIN

(71) Applicant: D-BRAND INC., Maple (CA)

(72) Inventor: Adam IJAZ, Maple (CA)

(73) Assignee: D-BRAND INC., Maple (CA)

(21) Appl. No.: 14/054,534

(22) Filed: Oct. 15, 2013

(51) Int. Cl. B44F 3/00; B32B 38/00; B32B 37/12

(52) U.S. Cl. CPC B44F 3/00; B32B 37/12; B32B 38/0004
USPC 428/131; 156/256

(57) ABSTRACT

The specification relates to a skin product for a device and a method of making the skin product. The skin product contains a design layer having a cut-out, and one or more design cut-outs positioned in the cut-out of the design layer. The method for making a skin product involves forming a cut-out on a design layer, forming one or more design cut-outs; and positioning the one or more design cut-outs in the cut-out in the design layer.

### FIELD

The specification relates to a skin product for a device and a process for making the same.

### BACKGROUND

Pre-formed skin products are currently available for electronic devices, such as, smart-phones, tablets, laptops and game controllers. Typically, such pre-formed skin products are made from molded plastic and have a particular shape and size for a specific product. Moreover, such pre-formed skin products generally have a hard shell that encases the electronic device.

The pre-formed skin products currently available in the market can add significant bulk to the size of the device, along with additional undesired weight. This can defeat the purpose of having a new age thinner and lighter device, such as a smart-phone. Moreover, the size and shape of the pre-formed skin products can nullify the physical design and appeal of a device. In addition, the choice of design and color of such skins is limited by the manufacturer, providing limited choice to the end-user, particularly, when the user desires a unique design or features, to develop distinctiveness for their device. Further, the molded plastic skin products can be easily removed, leaving the device vulnerable to scratches and other damage.

Alternate skin products can include printed image vinyl skins that can be applied to the device. Typically, such printed vinyl skins lack texture and are generally made of thin material that can provide little protection against scratches from sharp objects such as keys, blades and pins. Moreover, such printed image vinyl skins provide no ability to mix multiple materials to form the ultimate design.

A further type of skin product involves vinyl design pieces affixed to a vinyl base layer. Such design pieces can peel easily at the edges and can collect dust and grime around the edges of the piece, resulting in a design that will eventually become ruined. Moreover, such design pieces can be prone to damage on the design.

There is a need in the art for a skin product for devices that can reduce the amount of bulk and weight added to the device due to the skin product. In addition, there is a need in the art for a skin product that can be easily manufactured according to a design desired by the end user. Further, there is a need in the art for a skin product that is not readily removable from the device. Moreover, there is a need in the art for a method for manufacture of such a skin product.

### BRIEF DESCRIPTION OF THE DRAWINGS

Reference will now be made, by way of example, to the accompanying drawings which show example embodiments of the present application, and in which:

FIG. 1 shows the blank base layer of material in accordance with an embodiment disclosed in the specification;

FIG. 2 shows a vector illustration of a design in accordance with an embodiment disclosed in the specification;

FIG. 3 shows a secondary (design) layer of material with the cutout of the design in accordance with an embodiment disclosed in the specification;

FIG. 4 shows the design cutouts in accordance with an embodiment disclosed in the specification;

FIG. 5 shows that the nodes of the vector design is moved inwardly to form the design cutouts, in accordance with an embodiment disclosed in the specification;

FIG. 6 shows the blank base layer with cutouts removed and applied to a piece of non-stick paper in accordance with an embodiment disclosed in the specification;

FIG. 7 shows the alignment of the secondary (design) layer with the blank base layer in accordance with an embodiment disclosed in the specification;

FIG. 8 shows insertion of design cutouts into cutouts on the secondary (design) layer in accordance with an embodiment disclosed in the specification;

FIG. 9 show an embodiment of the final product in accordance with the disclosure in the specification;

FIG. 10 shows another embodiment of the skin product formed in accordance with the specification;

Similar reference numerals may have been used in different figures to denote similar components.

### SUMMARY OF INVENTION

In one aspect, the specification relates to a skin product for a device, containing:
a design layer having a cut-out; and
one or more design cut-outs positioned in the cut-out of the design layer.

In another aspect, the specification relates to a device having the skin product as disclosed herein.

In still another aspect, the specification relates to a method for making a skin product, the method containing the steps of:
forming a cut-out on a design layer;
forming one or more design cut-outs; and
positioning the one or more design cut-outs in the cut-out in the design layer.

### DESCRIPTION OF EXAMPLE EMBODIMENTS

This specification discloses a skin product for devices and a method for manufacturing and assembling the skin product. The material of construction for the skin product is not particularly limited and can depend upon the particular application and its requirements. In the specification herein, the skin product (2) disclosed is a vinyl skin for purposes of illustration, and which uses multiple pieces that fit together, like a puzzle, to form any intended design. For purposes of illustration and as an exemplary embodiment, the specification and figures disclose a skin (2) for the back of a phone which has the design of the letter “a”. As would be recognized by one of skill in the art, various designs can be made based on the teachings and disclosure of the specification.

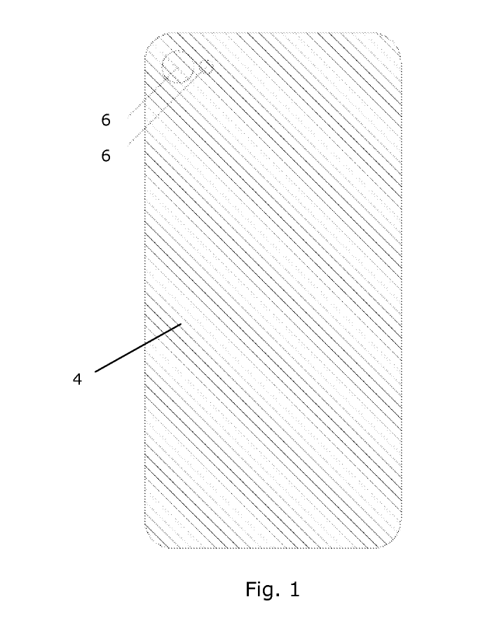

In one embodiment, for example and without limitation, the process begins with a base layer (4) of vinyl, cut in any size (FIG. 1). This base layer (4) can include openings (6) allowing for camera/flash/speaker/microphone/ports/etc. to function properly from underneath the openings, but does not include any cutouts in the shape of intended design. The size and shape of the base layer (4) is not particularly limited, and can depend upon the particular application requirements. In addition, the thickness of the base layer (4) is not particularly limited, and in one embodiment, for example and without limitation, is from about 152.4 microns to about 381 microns, although any thicker or thinner material may be used.

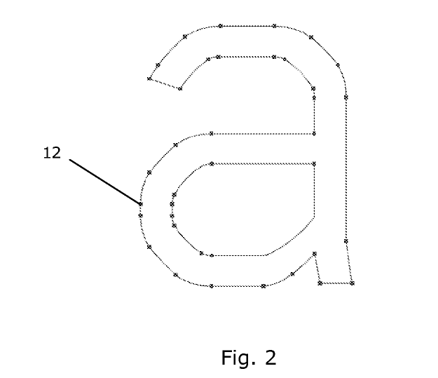

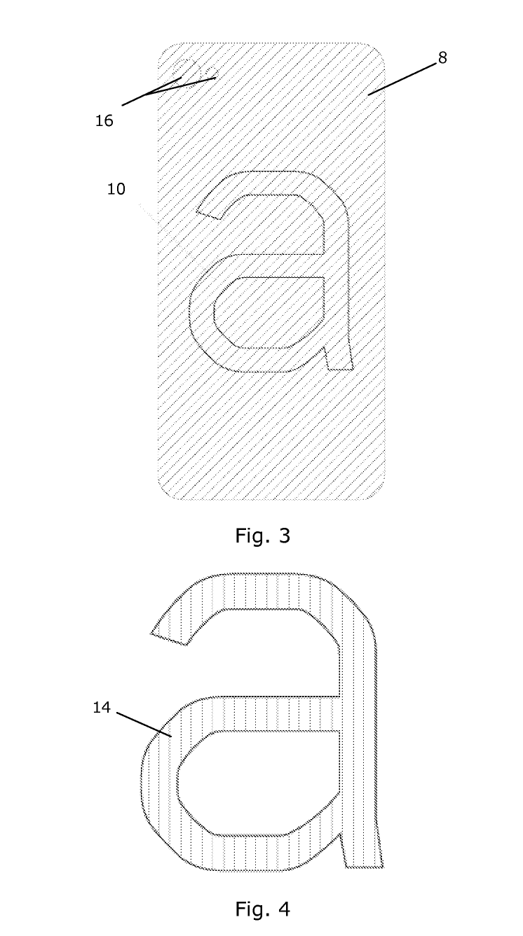

In one embodiment, a vector illustration of the design (FIG. 2) is created, which is to be formed on a second layer (8) of vinyl. The second layer (8) is also the design layer (8) of the skin product (2). The design layer (8) is cut in the same size and has apertures (16) that align with the openings (6) on the blank base layer (4) (shown in FIG. 1), but also includes cutouts (10) to form the outline of the design (FIG. 3). In one embodiment, the vector illustration created and shown in FIG. 2 includes a number of nodes or connecting points (12) that provide points along which the cutout (10) is made from the design layer (8). The cutout (10) can be made on the design layer (8) prior to assembly of the skin product (2) or during the assembly of the skin product (2), as disclosed herein.

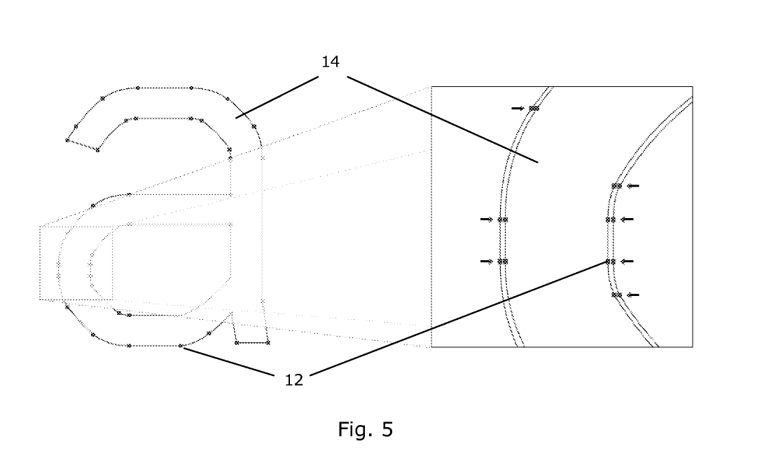

As shown in FIG. 5, the position of each node or connecting point (12) on the original vector illustration (FIG. 2) is moved inwardly by a distance, for example and without limitation, greater than 0.0 and less than 1 millimeter. The amended vector is then used to form the design cutouts (14) (FIG. 4). The design cutout (14) can be formed of a single piece or multiple pieces. In addition, the vector for the design cutouts (14) (FIG. 4) may be moved inwardly at nodes (12) by more than 1 millimeter, however, in a preferred embodiment, they would be moved no more than 1 millimeter than the vector illustration for the original design (FIG. 2). The inward change in position of the nodes or connecting points (12) of the vector is shown in FIG. 5. By moving the original vector illustration by a pre-defined amount, the design cutout (14) formed using the amended vector, can be spaced apart from the edge of the cutout (10) formed on the design layer (8). This allows the design cutout (14) to be more easily positioned in the cutout (10) of the design layer (8). Moreover, it can avoid overlapping of the edges of the cutout (10) formed in the design layer (8) and the edges of the design cutout (14), which can lead to a skin product (2) having a smooth finish lacking any sense of breaks or indentations in the skin product (2).

Once the blank base layer (4) (FIG. 1), design layer (8) (FIG. 3), and design cutouts (14) (FIG. 4) have been formed, assembly of the skin product (2) may begin. Although assembly can be performed prior to formation of all of the base layer (4), design layer (8) and the design cutouts (14), for purposes of simplicity, assembly is carried out after forming the base layer (4), design layer (8) and the design cutouts (14).

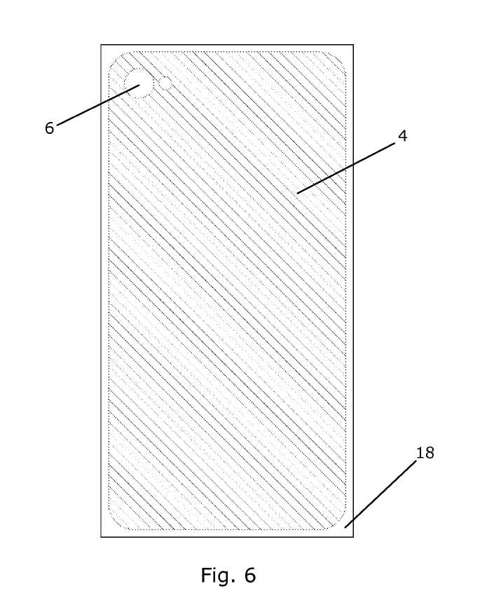

The blank base layer (4) having openings (6) has one side that is used for coupling to the design layer (8) and a second side to which can adhesive can be applied. The adhesive side of the base layer (4) is applied using an adhesive on either the surface of a device that is intended for application of the skin product (2), or onto any paper-style material or releasable liner (18). In the figures, assembly has been shown with the blank base layer (4) applied to a piece of releasable liner (18) (FIG. 6).

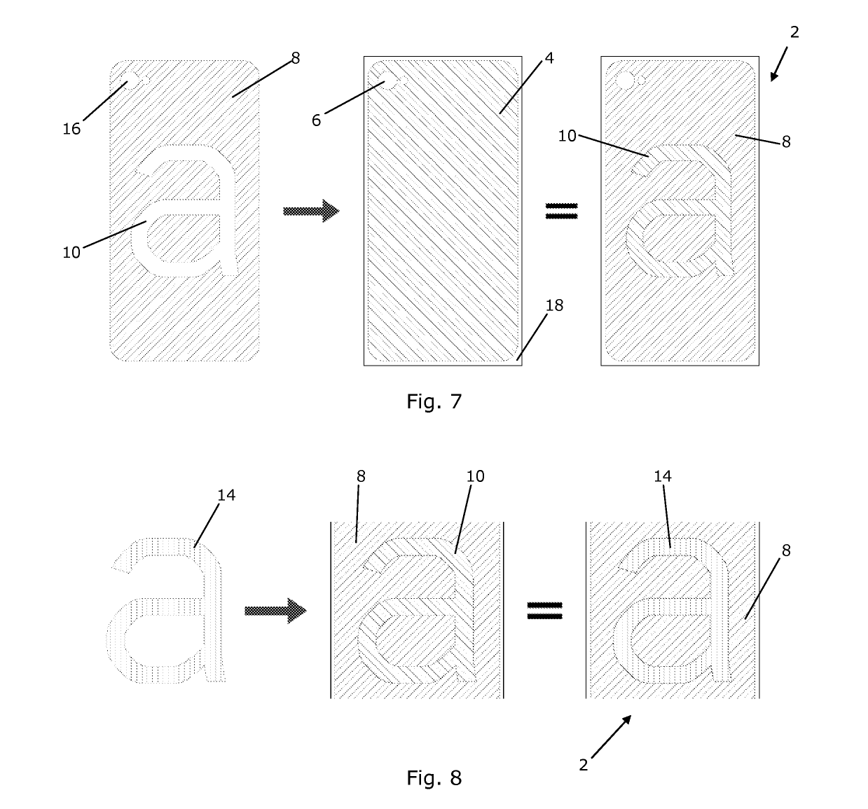

Similar to the base layer (4), the design layer (8) has an adhesive side that has adhesive applied on it. The other side of the design layer (8) is the external side that is visible to the users. The adhesive side of the design layer (8) is applied to the base layer (4) ensuring that the apertures (16) on the design layer (8) align with openings (6) on the base layer (2). The cutout (10) on the design layer (8) can be formed by removing the appropriate sections on the design layer (8) to provide the cutout (10). This can be done either before or after application of the design layer (8) to the base layer (4) (FIG. 7). In addition, application of the design layer (8) on the base layer (2) is carried out ensuring that the peripheral edges of the design layer (8) align and overlap with the peripheral edges of the base layer (2). This helps to provide a better appearance of the skin product (2), although slight misalignment can be acceptable when making the skin (2).

Upon application of the design layer (8) on the base layer (4), a dual-layer piece of the skin product (2) is formed, which has cutouts (10) of the intended design shape. If the cutouts (10) were not formed by removal of the appropriate sections from the design layer (8) prior to application of the design layer (8) to the base layer (4), the cutouts (10) can be formed after coupling of the two layers to provide the cutouts (10) in the design layer (8).

The design cutouts (14) formed earlier also have an adhesive side and an external side. As illustrated in FIG. 8, the adhesive side of the design cutouts (14) are then inserted into the slightly larger cutouts (10) in the design layer (8), and contact the base layer (4) for affixing the design cutouts (14) to the dual-layer piece of skin product (2). Application of the design cutout (14) can be done by hand or tweezers or using a machine.

As disclosed herein, the size of the design cutouts (14) is made slightly different than the size of the cutout (10) on the design layer (8). This can assist in application of the design cutouts (14) into the cutout (10) on the design layer (8). If the design cutouts (14) were of the same size as the cutout (10) in the design layer (8), it could result in potential overlapping of the design cutouts (14) with the design layer (8). Overlapping of the design cutouts (14) with the design layer (4) is not intended, as it can expose the edges of the design cutouts (14) and that can lead to an undesirable skin product (2).

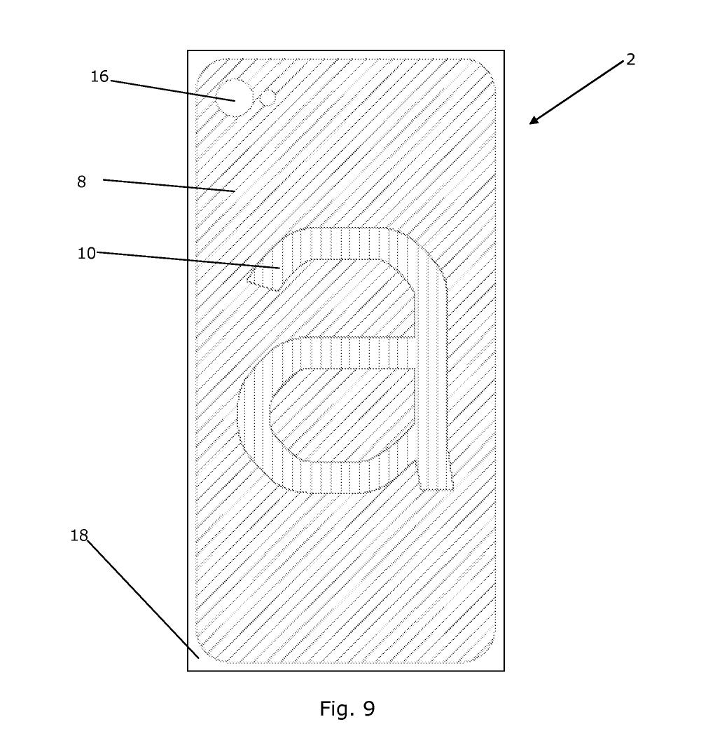

If during the application process, the design cutout (14) does overlap with the design layer (8), the design cutout (14) can be removed and re-applied within the cutout (10) in the design layer (8). If the design cutout (14) stretches or cannot be used without overlapping of the design cutout (14) with the design layer (8), a second piece of design cutout (14) can be made and applied within the edges of the design layer (8) that define the cutout (10). Thus, a final skin product (FIG. 9) having a smooth finish and providing a flat surface appearance can be formed.

Using the method disclosed herein, a skin product (2) having different textures, designs and colors can be made. Particularly, the design cutout (14) can be of different material than the design layer (8). Moreover, the design provided the design cutout (14) is protected within the cutout (10) in the design layer (8) and is not as readily prone to peeling, damage and dust accumulation. Moreover, the skin product (2) obtained appears like a seamless mono-layer, as the multiple layers combine to provide a single durable piece.

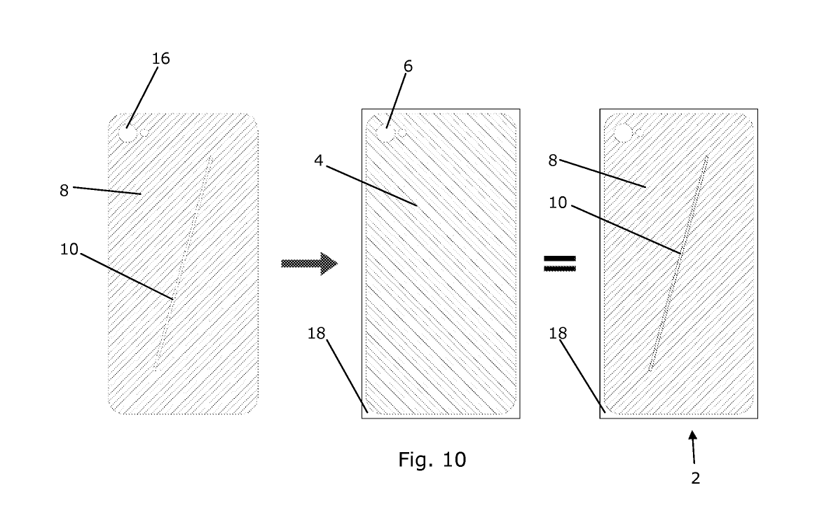

FIG. 10 shows an alternate embodiment of the skin product (2) in accordance with the specification. In the embodiment shown in FIG. 10, a design layer (8) having a cutout (10) is applied to the base layer (4), similar to the embodiment disclosed above. However, different from the embodiment disclosed above, a design cutout (14) is not applied within the cutout (10) in the design layer (8). Such an embodiment can be particularly useful, although not limited to, when the cutout (10) has dimensions that make it challenging to insert a design cutout (14) within the cutout (10) of the design layer (8). In addition, such an embodiment can be useful to disclose design features that may be present on the base layer (4).

In the embodiment shown in FIG. 10, the cutout (10) can be filled with a transparent or other filler material, such as, for example and without limitation, a clear epoxy or other polymeric material, to provide a skin product (2) having a smooth finish. Moreover, the cutout (10) disclosed in the embodiment of FIG. 10 can be combined with the embodiment shown in FIGS. 1-9, which would lead to a skin product (2) having multiple cutouts (10) that can have a design cutout (14) and a clear transparent filler to form the final skin product (2).

Certain adaptations and modifications of the described embodiments can be made. Therefore, the above discussed embodiments are considered to be illustrative and not restrictive.

### LIST OF PARTS

2 skin product
4 base layer
6 opening
8 second (design) layer
10 cutout
12 nodes or connecting points
14 design cutout
16 aperture
18 releasable liner

What is claimed is:

1. A skin product for a device, comprising:
a design layer having a cut-out; and
one or more design cut-outs positioned in the cut-out of the design layer.

2. The skin product of claim 1, further comprising a base layer coupled to the design layer and the design cut-outs on one side of the base layer; and the base layer being adapted for coupling to the device on a second side of the base layer.

3. The skin product of claim 1, wherein the one or more design cut-outs together have a shape similar to the shape of the cut-out in the design layer.

4. The skin product of claim 1, wherein the one or more design cut-outs together have a size similar to the size of the cut-out in the design layer.

5. The skin product of claim 1, wherein the one or more design cut-outs together have a peripheral edge portion, and the peripheral edge portion of the design cut-outs together being spaced from a peripheral edge of the design layer at the cut-out.

6. The skin product of claim 5, wherein the peripheral edge portion of the one or more design cut-outs together is spaced from greater than 0 mm to about 1 mm from the peripheral edge of the design layer defining the cut-out.

7. The skin product of claim 1, wherein the design cut-outs are of a different material or colour than the design layer.

8. The skin product of claim 1, wherein the design cut-out is formed is a one piece design cut-out.

9. The skin product of claim 1, wherein the design cut-out is formed by a plurality of pieces.

10. The skin product according to claim 1, further comprising a second cutout in the design layer, and a filler material positioned within the second cutout.

11. A device having the skin product as defined in claim 1.

12. A method for making a skin product, the method comprising:
forming a cut-out on a design layer;
forming one or more design cut-outs; and
positioning the one or more design cut-outs in the cut-out in the design layer.

13. The method of claim 12, further comprising:
forming a base layer having a first side and a second side;
coupling the design layer to the first side of the base layer; and
coupling the one or more design cut-outs to the base layer and positioned in the cut-out of the design layer;
wherein the design layer has about the same size and shape as the base layer.

14. The method of claim 12, wherein the one or more design cut-outs together have a size and shape similar to the cut-out in the design layer.

15. The method of claim 12, further comprising cutting the design cut-out along a peripheral edge portion for providing a space between the peripheral edge portion of the design cut-out and a peripheral edge of the design layer that definess the cut-out.

16. The method of claim 15, wherein the design cut-out is cut at a plurality of nodes along the peripheral edge portion of the design cut-out.

17. The method of claim 12, wherein the design cut-out are formed from a different material or colour from the design layer.

18. The method of claim 12, further comprising adhesive on the second side of the base layer for affixing the base layer to a device.

19. A method of application of a skin product to a device, comprising:
applying a base layer to the device;
applying a design layer having a cut-out to the base layer; and
applying one or more design cut-outs in the cut-out in the design layer and coupling the one or more design cutouts with the base layer.

20. The method of claim 19, wherein the design cutout is spaced from the edge of the design layer defining the cutout.
